(19) United States
(12) Patent Application Publication
(10) Pub. No.: US 2023/0388072 A1
(43) Pub. Date: Nov. 30, 2023

(54) METHODS AND APPARATUS FOR CONTROL OF APERIODIC SIGNALS AND REPORTS IN POSITIONING

(71) Applicant: Telefonaktiebolaget LM Ericsson (PUBL), Stockholm (SE)

(72) Inventors: Florent MUNIER, VÄSTRA FRÖLUNDA (SE); Siva MURUGANATHAN, STITTSVILLE (CA); Ritesh SHREEVASTAV, UPPLANDS VÄSBY (SE)

(21) Appl. No.: 18/248,892

(22) PCT Filed: Oct. 18, 2021
(86) PCT No.: PCT/EP2021/078831

§ 371 Date: Apr. 13, 2023

Related U.S. Application Data
(60) Provisional application No. 63/092,866, filed on Oct. 16, 2020.

(51) Int. Cl. H04L 5/00; H04W 76/20; H04W 72/232

(52) U.S. Cl. CPC H04L 5/0048; H04W 76/20; H04W 72/232

(57) ABSTRACT

A method by a wireless device includes receiving, from a first network node, assistance information that includes at least one information element that indicates at least one resource type associated with at least one reference signal (RS). The at least one resource type indicates at least one type of RS selected from: Positioning Reference Signal (PRS), Channel State Information-Reference Signal (CSI-RS), and Tracking Reference Signal (TRS).

### TECHNICAL FIELD

The present disclosure relates, in general, to wireless communications and, more particularly, methods and apparatus for control of aperiodic signals and reports in positioning.

### BACKGROUND

Positioning has been a topic in Long Term Evolution (LTE) standardization since 3^{rd} Generation Partnership Project (3GPP) Release 9. The primary objective was initially to fulfill regulatory requirements for emergency call positioning but other use case like positioning for Industrial-Internet of Things (I-IoT) are becoming important.

FIG. 1 illustrates an architecture supporting positioning in New Radio (NR). More specifically, FIG. 1 illustrates NG RAN Rel-15 Location Services (LCS) Protocols. It may be noted that, though depicted in FIG. 1, the gNB and ng-eNB may not always both be present. When both the gNB and ng-eNB are present, the NG-C interface is only present for one of them.

Location Management Function (LMF) is the location node in NR. There are also interactions between the location node and the gNodeB (gNB) via NR Positioning Protocol A (NRPPa). The interactions between the gNB and the device is supported via the Radio Resource Control (RRC) protocol, while the location node interfaces with a User Equipment (UE) via the LTE positioning protocol (LPP). LPP is common to both NR and LTE.

In the legacy LTE standards, the following techniques are supported:
Enhanced Cell Identifier (ID): Essentially, cell ID information is used to associate the device to the serving area of a serving cell, and then additional information is used to determine a finer granularity position.
Assisted Global Navigation Satellite Systems (GNSS): GNSS information is retrieved by the device, supported by assistance information provided to the device from Enhanced-Serving Mobile Location Center (E-SMLC).
Observed Time Difference of Arrival (OTDOA): The device estimates the time difference of reference signals from different base stations and sends to the E-SMLC for multilateration.
Uplink TDOA (UTDOA): The device is requested to transmit a specific waveform that is detected by multiple location measurement units (e.g. an eNodeB (eNB)) at known positions. These measurements are forwarded to E-SMLC for multilateration

In NR Rel. 16, a number of positioning features were specified.

A new downlink (DL) reference signal, the NR DL Positioning Reference Signal (PRS), was specified. The main benefit of this signal in relation to the LTE DL PRS is the increased bandwidth, which is configurable from 24 to 272 Resource Blocks (RBs) and gives a big improvement in Time of Arrival (TOA) accuracy. The NR DL PRS can be configured with a comb factor of 2, 4, 6 or 12. Comb-12 allows for twice as many orthogonal signals as the comb-6 LTE PRS. Beam sweeping is also supported on NR DL PRS in Rel. 16.

In NR Rel. 16, enhancements of the NR Uplink (UL) Sounding Reference Signal (SRS) were specified. The Rel. 16 NR SRS for positioning allows for a longer signal (up to 12 symbols as compared to 4 symbols in Rel. 15), and a flexible position in the slot (only last six symbols of the slot can be used in Rel. 15). It also allows for a staggered comb Reference Element (RE) pattern for improved TOA measurement range and for more orthogonal signals based on comb offsets (comb 2, 4 and 8) and cyclic shifts. The use of cyclic shifts longer than the Orthogonal Frequency Division Multiplexing (OFDM) symbol divided by the comb factor is, however, not supported by Rel. 16 despite that this is the main advantage of comb-staggering at least in indoor scenarios. Power control based on neighbor cell Synchronization Signal Block (SSB)/DL PRS is supported as well as spatial Quasi Co-Location (QCL) relations towards a Channel State Information-Reference Signal (CSI-RS), an SSB, a DL PRS or another SRS.

In NR Rel. 16, the following UE measurements are specified:
DL Reference Signal Time Difference (RSTD), allowing for e.g. DL TDOA positioning
Multi cell UE Receiver-Transceiver (Rx-Tx) Time Difference measurement, allowing for multi cell Return Trip Time (RTT) measurements
DL PRS RSRP

In NR Rel. 16, the following gNB measurements are specified
UL-RTOA, useful for UL TDOA positioning
gNB Rx-Tx time difference, useful for multi cell RTT measurements
UL SRS-RSRP
Angle of Arrival (AoA) and Zenith Angle of Arrival (ZoA)

In December 2019, a study item on positioning with focus on Industrial IOT scenarios was initiated. One of the objectives in the 3GPP NR Rel. 17 positioning study item is to study high (horizontal and vertical) positioning accuracy with low latency and network efficiency (scalability, RS overhead, etc.). In this regard, on demand reference signals for positioning is of interest since it allows the possibility to achieve high positioning accuracy with low latency and network efficiency. Particularly, on demand reference signals are beneficial since they can reduce reference signal overhead and improve network efficiency.

Different types of reference signals for positioning may include PRS, CSI-RS, and aperiodic RS triggering.

The PRS is configured by each cell separately, and the location server (LMF) collects all configurations via the NRPPa protocol, before sending an assistance data (AD) message to the UE via the LPP protocol.

PRS is organized in a 3-level hierarchy:
PRS frequency layer: gathers PRS resource sets from (potentially) multiple base station, having common parameters in common. If two resource sets are in the same frequency layer, they:
   Operate in the same band with the same subcarrier spacing
   Have the same comb factor
   Have the same starting PRB and bandwidth
PRS Resource set: corresponds to a collection of PRS beams (resources) which are all originating from the same base station. All resource in the same set have the same comb factor
PRS resource: correspond to a beam transmitting the PRS

The CSI-RS is not used in time-based or angle based positioning methods in NR. Currently, it is supported as part of the Enhanced-Cell ID (E-CID) methods for power measurements (CSI Reference Signal Received Power (RSRP) and CSI Reference Signal Received Quality (RSRQ)). The CSI-RS is configured via RRC configuration in the UE serving cell. Aperiodic CSI-RS and semi-persistent CSI-RS are activated via Downlink Control Information (DCI) triggers (aperiodic) or Medium Access Control-Control Element (MAC CE) activation (semi persistent). CSI-RS may be measured coming from the serving cell or the non-serving cell, using the interference measurement framework.

Aperiodic signals are typically DCI triggered. For example aperiodic SRS is triggered via DCI field “SRS request” codepoints configured, where code points labelled 1 to 3 will trigger a group of SRS resource sets which are configured with the same code point value in the RRC configuration. Code point 0 is reserved to signal no triggering.

Similarly, aperiodic CSI-RS is triggered by the CSI request field in DCI which may consist of 0, 1, 2, 3, 4, 5, or 6 bits as determined by higher layer parameter reportTriggerSize (DCI format 0_1) or reportTriggerSizeForDCI-Format0-2 (for DCI format 0_2). The trigger states themselves are listed in higher layer parameters CSI-AperiodicTriggerStateList Each CSI-AperiodicTriggerState may be associated with multiple CSI Report configurations. A field CSI-AssociatedReportConfigInfo is used in 3GPP TS 38.331 to associate a CSI Report Configuration to a CSI-AperiodicTriggerState. The CSI Resource Configuration to be used for channel measurement is provided in the CSI Report Configuration. If the CSI Resource Configuration contains multiple CSI-RS resource sets, then which CSI-RS resource set to use for channel measurement is given in the CSI-AssociatedReportConfigInfo field.

It should be noted that the CSI report itself (different from the CSI RS transmission) can be configured to be either periodic, semi persistent or aperiodic. However, if the CSI-RS transmission is aperiodic, the CSI report also must be configured to be aperiodic.

As of Rel. 16, positioning in NR only supports on-demand signals in the uplink, with aperiodic and semi-persistent procedures for the UL SRS for positioning. The procedures enable sending on-demand UL signals from the UE to the serving and neighbor cells.

FIG. 2 illustrates the UL-TDOA positioning procedure. In step 5b, the SRS is either triggered (aperiodic SRS) or activated (semi-persistent SRS). The UE is connected to a serving cell where it receives a Physical Downlink Control Channel (PDCCH) with downlink control information (DCI) with a trigger pointing to an SRS configuration. The SRS configuration is semi static (RRC configured) and contains information defining where in the NR time-frequency grid to send the SRS, including which symbol in the slots carry the SRS, and how the SRS is mapped to resource elements in the frequency domain. The exact slot in which the SRS is transmitted is based on when the SRS trigger is received by the UE, a UE processing capability and the configured delay called “slotOffset” configured to the UE.

For semi-persistent SRS, the procedure is similar to aperiodic but also gives the possibility to the UE to receive more than 1 instance of the SRS. The semi persistent procedure is initiated by a Medium Access Control Control Element (MAC CE) which activates the semi-persistent SRS and stopped by another MAC CE which deactivates the semi-persistent SRS. Between the two MAC CEs (i.e., activating and deactivating MAC CEs), the SRS is periodically transmitted by the UE as configured.

A cell can consist of multiple Transmission Reception Points (TRPs) with each TRP located in distinct coordinates as shown in below FIG. 3. This sort of configurations is expected to be used in I-IOT scenarios. As an example, one cell with 10, 20 or even more TRPs may be used to cover a complete factory hall.

For positioning, three distinct co-ordinates are required to perform multilateration. With this sort of scenario where a serving cell has multiple TRPs located in distinct co-ordinates, it should be possible to exploit this for positioning.

Certain problems exist, however. One such problem relates to latency of existing downlink signals and procedures for positioning. For example, in release 17, 3GPP extended the use cases for positioning to indoor industrial applications such as Industrial Internet-of-Things (IIOT), where low latency and high accuracy are paramount. In these applications, it is desirable to have on-demand (aperiodic and semi-persistent) DL RS supported in Rel. 17 to complement the existing periodic DL PRS configuration.

How to trigger on demand reference signals, which can be aperiodic and their associated positioning reports, is an open problem that needs to be solved.

### SUMMARY

Certain aspects of the present disclosure and their embodiments may provide solutions to these or other challenges. For example, according to certain embodiments, methods and systems are provided for sending on-demand DL RS for positioning.

According to certain embodiments, a method by a wireless device includes receiving, from a first network node, at least one information element that indicates at least one resource type associated with at least one RS. The at least one resource type indicates at least one type of RS selected from: PRS, CSI-RS, and TRS.

According to certain embodiments, a wireless device is adapted to receive, from a first network node, at least one information element that indicates at least one resource type associated with at least one RS. The at least one resource type indicates at least one type of RS selected from: PRS, CSI-RS, and TRS.

According to certain embodiments, a method by a first network node includes transmitting, to a wireless device, at least one information element that indicates at least one resource type associated with at least one RS. The at least one resource type indicates at least one type of RS selected from: PRS, CSI-RS, and TRS.

According to certain embodiments, a network node is adapted to transmit, to a wireless device, at least one information element that indicates at least one resource type associated with at least one RS. The at least one resource type indicates at least one type of RS selected from: PRS, CSI-RS, and TRS.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates an architecture supporting positioning in NR;

FIG. 2 illustrates the UL-TDOA positioning procedure;

FIG. 3 illustrates multi-TRP in a cell;

FIG. 4 illustrates an example showing positioning report configuration identifier being provided as part of the CSI-AssociatedReportConfigInfo, according to certain embodiments;

FIG. 5 illustrates an example showing a list of Pos-AssociatedReportConfigInfo as part of CSI-AperiodicTriggerState, according to certain embodiments;

FIG. 6 illustrates an example showing a new information element containing a list of Aperiodic Positioning trigger states, according to certain embodiments;

FIG. 7 illustrates code point-based PRS configuration and reconfiguration, according to certain embodiments;

FIG. 8 illustrates Serving cell based DCI Trigger, according to certain embodiments;

FIG. 9 illustrates an example wireless network, according to certain embodiments;

FIG. 10 illustrates an example network node, according to certain embodiments;

FIG. 11 illustrates an example wireless device, according to certain embodiments;

FIG. 12 illustrate an example user equipment, according to certain embodiments;

FIG. 13 illustrates a virtualization environment in which functions implemented by some embodiments may be virtualized, according to certain embodiments;

FIG. 14 illustrates a telecommunication network connected via an intermediate network to a host computer, according to certain embodiments;

FIG. 15 illustrates a generalized block diagram of a host computer communicating via a base station with a user equipment over a partially wireless connection, according to certain embodiments;

FIG. 16 illustrates a method implemented in a communication system, according to one embodiment;

FIG. 17 illustrates another method implemented in a communication system, according to one embodiment;

FIG. 18 illustrates another method implemented in a communication system, according to one embodiment;

FIG. 19 illustrates another method implemented in a communication system, according to one embodiment;

FIG. 20 illustrates an example method by a wireless device, according to certain embodiments;

FIG. 21 illustrates an exemplary virtual computing device, according to certain embodiments;

FIG. 22 illustrates another example method by a wireless device, according to certain embodiments;

FIG. 23 illustrates an exemplary virtual computing device, according to certain embodiments;

FIG. 24 illustrates an example method by a network node, according to certain embodiments;

FIG. 25 illustrates another exemplary virtual computing device, according to certain embodiments;

FIG. 26 illustrates another example method by a network node, according to certain embodiments; and

FIG. 27 illustrates another exemplary virtual computing device, according to certain embodiments.

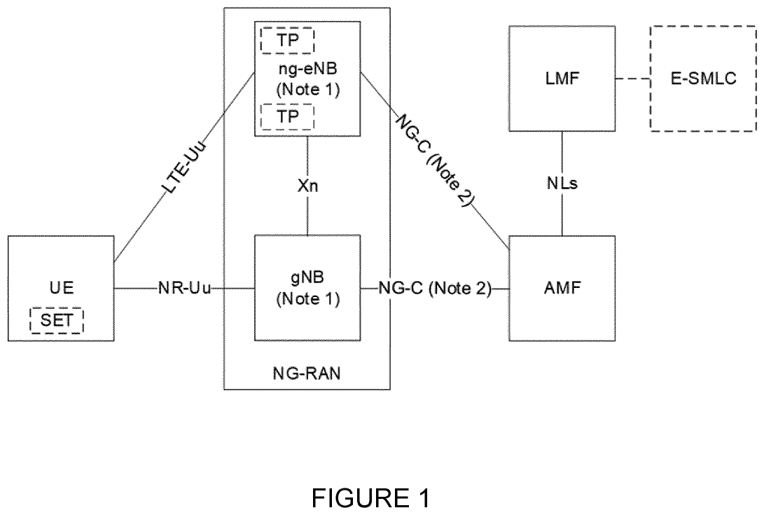

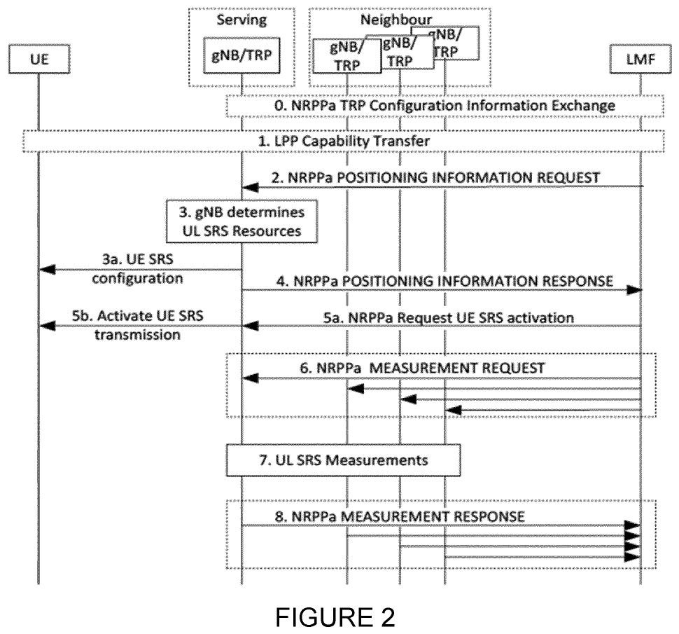

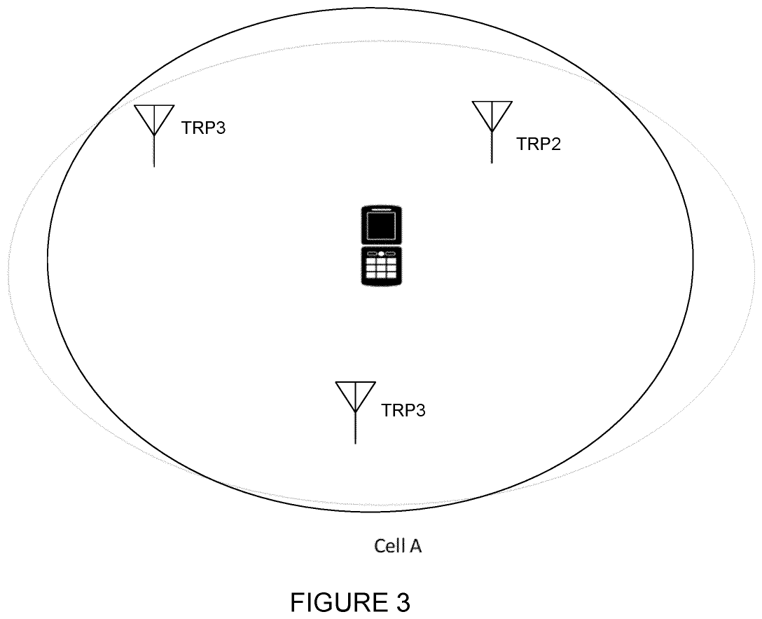

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In some embodiments, a more general term “network node” may be used and may correspond to any type of radio network node or any network node, which communicates with a UE (directly or via another node) and/or with another network node. Examples of network nodes are NodeB, MeNB, ENB, a network node belonging to MCG or SCG, base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g. MSC, MME, etc.), O&M, OSS, SON, positioning node (e.g. E-SMLC), MDT, test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), USB dongles, UE category M1, UE category M2, ProSe UE, V2V UE, V2X UE, etc.

Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNB, or UE.

According to certain embodiments, methods and systems are provided for sending on-demand DL RS for positioning. The architecture for such methods and systems may include the following items:
Choice of RS, e.g. CSI-RS, PRS, or other downlink reference signals
Method for activation, i.e. trigger-based (aperiodic)
   Includes Methods for serving cell and neighbouring cells
Protocol for connectivity (RRC, LPP, NRPPa), for configuration and measurement reporting

Certain embodiments disclosed herein propose methods for triggering of aperiodic reference signals for positioning. The target RS are the PRS and the CSI-RS. However, the methods and systems may be applied to other types of reference signals such as, for example, TRS.

Some protocol aspects related to the configuration of the activation as well as some aspects of measurement reporting are also disclosed.

Procedure to configure aperiodic RS for positioning

Configuration of the Activation Trigger

Configuration of an Aperiodic PRS Type

As of today, there is no specific type for the PRS, as only periodic PRS is supported in NR to date. In one embodiment, the PRS resource can be configured with a new parameter/Information Element (IE), which may be at the resource level, resource set level, or PRS frequency layer level. This parameter could take the name “resource type”, and take the value of “periodic, aperiodic, semipersistent”. In the absence of this parameter, the UE shall assume the PRS is configured as “periodic”, according to certain embodiments. The parameter may be part of the configuration of PRS in either the LPP protocol, or another protocol such as RRC.

DCI-Based Activation

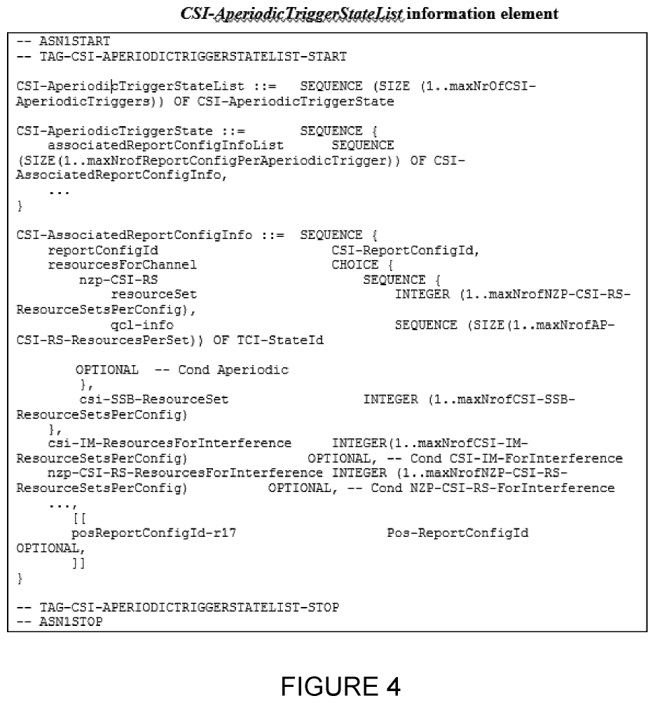

The PRS configuration is forwarded to the LMF by the gNB, which in turn would forward the configuration to the UE. In a particular embodiment, when the PRS is configured with a resource type of “aperiodic”, the PRS is connected to a DCI triggering state using any one of the following particular embodiments:
In one embodiment, the PRS ID of the IE containing the aperiodic configuration (be it in PRS resource ID, resource set ID, or frequency layer ID) is listed as part of the trigger state (either in the trigger state or as part of another field in the trigger state) triggered by a CSI request codepoint (i.e., as part of the CSI-AperiodicTriggerState configuration in TS38.331 V16.2.0 (2020 September).
In another embodiment, a positioning report configuration or a positioning report configuration identifier is provided as part of the CSI-AssociatedReportConfigInfo. FIG. 4 illustrates an example showing positioning report configuration identifier being provided as part of the CSI-AssociatedReportConfigInfo, according to certain embodiments.
The positioning report configuration or its identifier provided as part of the CSI-AssociatedReportConfigInfo may correspond to any one of the positioning methods including and not limited to as NR DL-TDOA, NR DL-AoD, and NR Multi-RTT. Further, the associated method would also imply which positioning measurements/reports (RSTD, RSRP, UE Rx-TX) are required.
   According to certain embodiments, the positioning report configuration may correspond to a positioning report that is to be aperiodically triggered.
   According to certain embodiments, the information related to the DL PRS resource to be aperiodically triggered is provided as part of the positioning report configuration. For instance, the information related to the DL PRS resource to be aperiodically triggered may be in the form of an ID such as PRS resource set ID, PRS resource ID, etc. or a list of PRS resource sets. Note that in this embodiment, the positioning report configuration and the CSI report configuration are provided in the same CSI-AssociatedReportConfigInfo, and hence both the positioning report and the CSI report can be triggered jointly when a CSI-AperiodicTriggerState with which the CSI-AssociatedReportConfigInfo is associated is triggered by the CSI request field of a DCI. In some embodiments, the positioning report configuration in CSI-AssociatedReportConfigInfo is optional.
   In some further embodiments, when there are multiple PRS resource sets associated with a TRP, the PRS resource set (or an identifier of such a resource set) to be used for positioning measurement may be provided explicitly as part of CSI-AssociatedReportConfigInfo. In some cases, when positioning measurement involves measurement on more than one TRP, then PRS resource sets (or identifiers of such resource sets) each corresponding to one of the more than one TRP may be provided explicitly as part of CSI-AssociatedReportConfigInfo.
   According to certain embodiments, the quasi-collocation information (QCL) as defined in 3GPP TS38.214 V16.3.0 for the triggered PRS resource or PRS resource set may be provided as part of CSI-AssociatedReportConfigInfo.
   Even though the examples described herein are written with respect to positioning reports which use PRS for positioning measurements, the above embodiments are equally valid when aperiodic CSI-RS is used for positioning measurements.

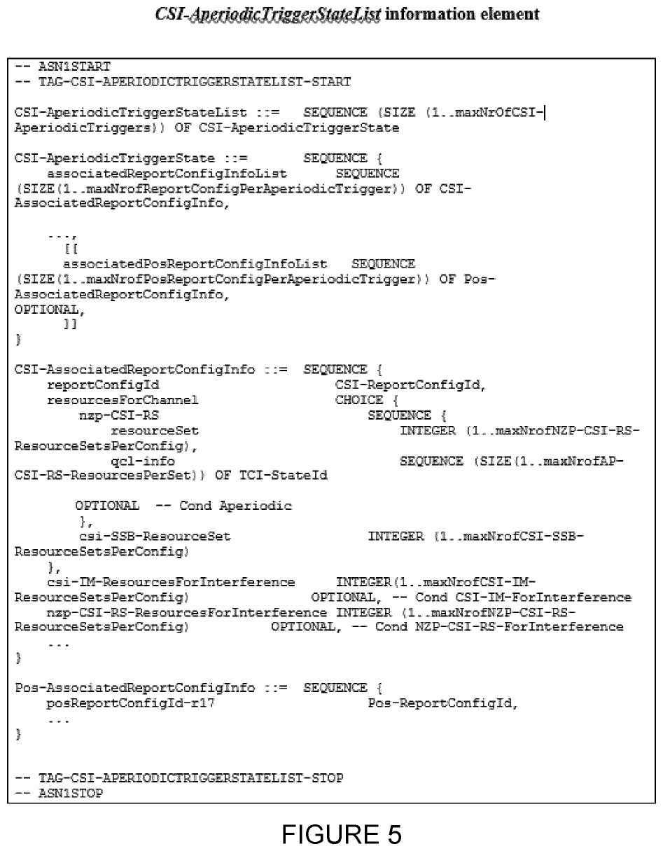

According to certain embodiments, a list of associated positioning report configurations is provided as part of each CSI-AperiodicTriggerState. FIG. 5 illustrates an example showing a list of Pos-AssociatedReportConfigInfo as part of CSI-AperiodicTriggerState, according to certain embodiments. In each Pos-AssociatedReportConfigInfo, a positioning report configuration or a positioning report configuration identifier is provided. The positioning report configuration or its identifier provided as part of the Pos-AssociatedReportConfigInfo may correspond to any one of the positioning methods including and not limited to as NR DL-TDOA, NR DL-AoD, and NR Multi-RTT.

According to certain embodiments, the positioning report configuration may correspond to a positioning report that is to be aperiodically triggered.

According to certain embodiments, the information related to the DL PRS resource to be aperiodically triggered is provided as part of the positioning report configuration. For instance, the information related to the DL PRS resource to be aperiodically triggered may be in the form of an ID such as PRS resource set ID, PRS resource ID, etc. or a list of PRS resource sets. Note that in this embodiment, the list of associated positioning report configuration information (associatedPosReportConfigInfoList) and the list of associated CSI report configuration information (associatedReportConfigInfoList) are provided as part of the same CSI-AperiodicTriggerState. Hence, it is possible to trigger one or more positioning reports (the exact number given by the size of associatedPosReportConfigInfoList) and one or more CSI reports (the exact number given by the size of associatedReportConfigInfoList) jointly when the CSI-AperiodicTriggerState is triggered by the CSI request field of a DCI.

According to certain embodiments, the list of positioning report configurations in CSI-AperiodicTriggerState is optional. This allows a first CSI-AperiodicTriggerState to be associated with only CSI report configurations (i.e., associatedPosReportConfigInfoList is not configured as part to the first CSI-AperiodicTriggerState) and a second CSI-AperiodicTriggerState to be associated with both CSI report configurations and positioning report configurations (i.e., associatedPosReportConfigInfoList is configured as part to the first CSI-AperiodicTriggerState).

In some further particular embodiments, when there are multiple PRS resource sets associated with a TRP, the PRS resource set (or an identifier of such a resource set) to be used for positioning measurement may be provided explicitly as part of Pos-AssociatedReportConfigInfo. In some cases, when positioning measurement involves measurement on more than one TRP, then PRS resource sets (or identifiers of such resource sets) each corresponding to one of the more than one TRP may be provided explicitly as part of Pos-AssociatedReportConfigInfo.

According to certain embodiments, the quasi-collocation information (QCL) as defined in 3GPP TS38.214 V16.3.0 for the triggered PRS resource or PRS resource set may be provided as part of Pos-AssociatedReportConfigInfo.

Even though the examples described herein are written with respect to positioning reports which use PRS for positioning measurements, the above embodiments are equally valid when aperiodic CSI-RS is used for positioning measurements.

In another particular embodiment, the PRS and CSI-RS have each separate, pre-allocated CSI request code points. The code points can be allocated as CSI codepoint or PRS codepoint by two additional separate RRC parameters listing the CSI codepoints and PRS codepoint, respectively. Alternatively, a codepoint is declared as a PRS code point or a CSI codepoint via a type indicator parameter in the CSI-AperiodicTriggerState information element.

In another particular embodiment, the maximum number of configurable trigger states associated with a PRS or trigger states/Pos-AssociatedReportConfigInfo associated with positioning reports is reported as part of UE capability.

In another embodiment, the PRS ID of the IE containing the aperiodic configuration (be it in PRS resource ID, resource set ID, or frequency layer ID, respectively), is listed as part of a new list of resource triggered by a CSI request codepoint, as an example named PRS-AperiodicTriggerState configuration. The PRS-AperiodicTriggerState configuration maps to a single code point of a field in DCI (for example, this field can be a new field introduced in either downlink or uplink DCI or the existing CSI Request field in DCI), part of a new parameter listing aperiodic PRS trigger code points PRS-AperiodicTriggerStateList. In a particular embodiment each member of the PRS-AperiodicTriggerStateList can be triggered by the CSI-request field of the DCI. In a particular embodiment, each member of the PRS-AperiodicTriggerStateList can be triggered by a new, RRC configurable (optional) PRS-request field of the DCI.

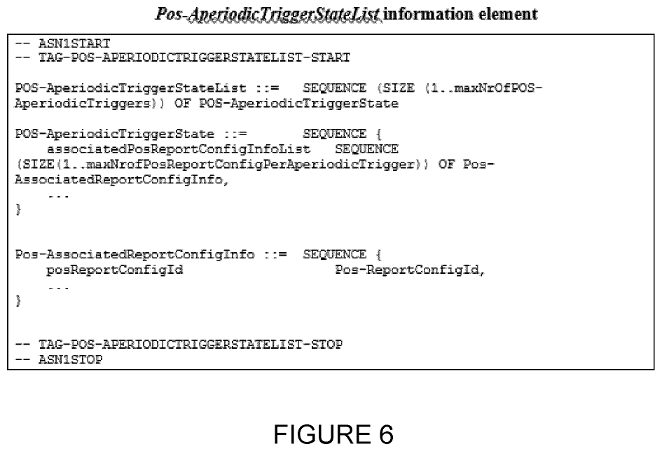

In another embodiment, a new IE Pos-AperiodicTriggerStateList is introduced containing a list of aperiodic Positioning trigger states. FIG. 6 illustrates an example showing a new information element containing a list of Aperiodic Positioning trigger states, according to certain embodiments. The trigger states (i.e., POS-AperiodicTriggerState's) may be mapped to codepoints of a new DCI field introduced in either downlink or uplink DCI specifically for triggering positioning reports. Alternatively, these POS-AperiodicTriggerState's may be mapped to codepoints of an existing DCI field such as CSI Request field.

According to certain embodiments, when an existing DCI field's codepoints are mapped to the POS-AperiodicTriggerState's, the CRC associated with the DCI payload may be scrambled with a new RNTI. For instance, when the CRC associated with the DCI payload is scrambled with a first RNTI, then the existing DCI field's codepoints are mapped to the POS-AperiodicTriggerState's. When the CRC associated with the DCI payload is scrambled with a second RNTI, then the existing DCI field's codepoints are mapped to the another set of AperiodicTriggerState's (e.g., CSI-AperiodicTriggerState's).

The positioning report configuration or its identifier provided as part of the Pos-AssociatedReportConfigInfo may correspond to any one of the positioning methods including and not limited to as NR DL-TDOA, NR DL-AoD, and NR Multi-RTT. In some embodiments, the positioning report configuration may correspond to a positioning report that is to be aperiodically triggered. In some embodiments, the information related to the DL PRS resource to be aperiodically triggered is provided as part of the positioning report configuration. For instance, the information related to the DL PRS resource to be aperiodically triggered may be in the form of an ID such as PRS resource set ID, PRS resource ID, etc. or a list of PRS resource sets.

According to certain further embodiments, when there are multiple PRS resource sets associated with a TRP, the PRS resource set (or an identifier of such a resource set) to be used for positioning measurement may be provided explicitly as part of Pos-AssociatedReportConfigInfo. In some cases, when positioning measurement involves measurement on more than one TRP, then PRS resource sets (or identifiers of such resource sets) each corresponding to one of the more than one TRP may be provided explicitly as part of Pos-AssociatedReportConfigInfo.

According to certain embodiments, the quasi-collocation information (QCL) as defined in 3GPP TS38.214 V16.3.0 for the triggered PRS resource or PRS resource set may be provided as part of Pos-AssociatedReportConfigInfo.

Even though the examples described herein are written with respect to positioning reports which use PRS for positioning measurements, the above embodiments are equally valid when aperiodic CSI-RS is used for positioning measurements.

### Signaling for Combined LPP and NRPPa Based Activation

Alternatively, the trigger could be sent via LPP, via a specific request to measure on an aperiodic resource. In this case, the sequence to measure an aperiodic resource may include:
LMF will first need to request via NRPPa the transmission of a PRS aperiodic resource (or resource set) form a base station (gnodeB), and receive an NRPPa acknowledgement from that base station.
LMF will second transmit an LPP message to the UE to measure and report the PRS resource (resource set)

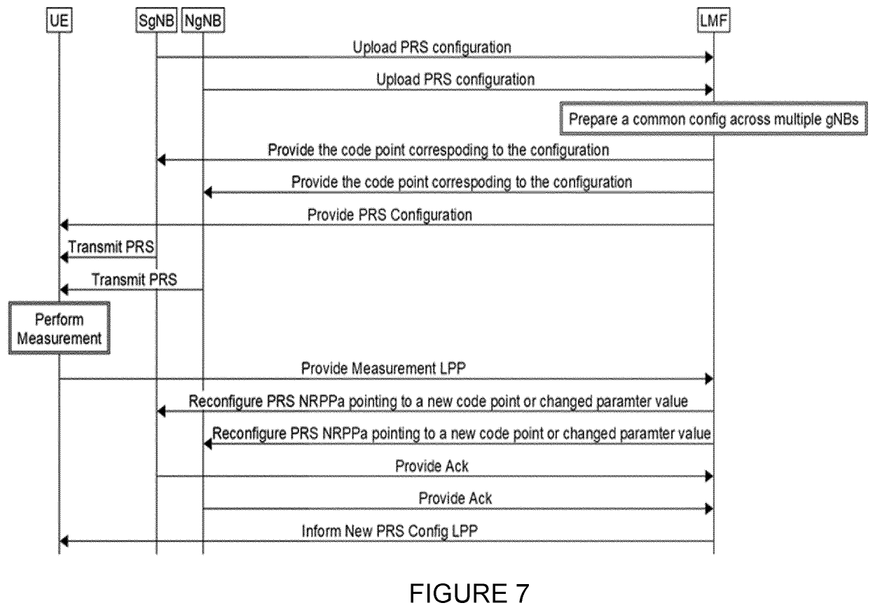

FIG. 7 illustrates code point-based PRS configuration and reconfiguration, according to certain embodiments. As illustrated in FIG. 7, the sequence includes:
1. Either Via NRPPa or OAM; each gNB provides its supported PRS (DL-PRS or CSI-RS) config to LMF
2. LMF prepares the PRS configuration. The prepared configuration is common across multiple gNBs and LMF maintains a code point for each PRS configuration similar to DCI code points. The code points have a pre-defined value indicating but not limiting to: Periodic, semi-persistent, aperiodic; Number of resource sets, number of resources; Periodicity; Comb pattern; Number of PRS subframes; PRS Bandwidth; Frequency layer.
3. LMF provides the code point via NRPPa to each involved gNBs and to UE via LPP
4. gNBs (SgNB: serving, NgNB: Neighbor) transmit the PRS accordingly
5. UE provides the result to LMF via LPP
6. If LMF wants to alter any config; it may provide another codepoint or send a reconfiguration message to each gNB.
7. Once the gNB provides an ack that reconfig is possible then;
8. The LMF provides the info to UE via LPP.
   It may be noted that, for serving cell only based aperiodic configuration, it is possible that instead of LPP, the gNB notifies the new configuration to UE via serving cell DCI configurations.

### Serving Cell Based Trigger

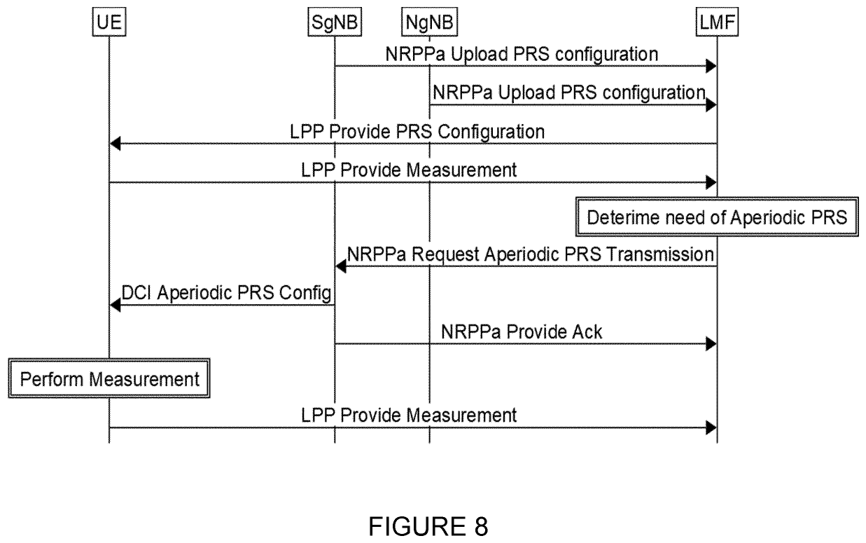

For serving cell based Aperiodic DCI trigger, in order to reduce the latency that may occur because of NRPPa/LPP based trigger, one may consider serving cell based trigger. FIG. 8 illustrates serving cell based DCI trigger, according to certain embodiments.

LMF may determine the need of aperiodic PRS and may send a request for such to serving gNB. Serving gNB may then trigger the DCI and provide an acknowledgment (ACK) to the LMF. UE performs the measurement and provides the result to LMF via LPP as shown in FIG. 8. While providing in assistance data, LMF may include the code points with regards to aperiodic PRS transmission. When recommending the aperiodic PRS, the LMF may include the code point in NRPPa. gNB then triggers the corresponding DCI.

Further, gNB may decide the need of aperiodic trigger on its own. For example, gNB may determine the need for aperiodic trigger based upon any Xn inter change from neighbor gNB on PRS beam info or any other input received from LMF (PRS beam reconfiguration) or based upon RRM measurements received from the UE or other UEs in the serving cell. In such case, RRC may be used to preconfigure the aperiodic code points and the serving cell may then use the DCI to activate the aperiodic PRS configuration.

### Collection and Reporting of Measurements

LPP Reporting for CSI-RS

In the existing framework for positioning in 3GPP, reporting of measurement is mostly done via the LPP protocol, connecting the UE to the location server (LMF).

CSI-RS is currently supported for NR positioning only in the NR E-CID methods, which uses CSI RSRP and RSRQ measurement reported by RRC. According to certain embodiments, the following measurement extension(s) are proposed:
In a particular embodiment, the CSI-RS can be used to measure DL-TDOA as specified in 3GPP specification 38.215, replacing the PRS resource with a CSI-RS resource.
   CST-RS is added as a potential source for measurement in the assistance data of OTDOA, for example as a member of the NR-DL-TDOA-ProvideAssistanceData-r16 IE in the assistance data message from the Location server to the UE
   For reporting of DL-TDOA measurements, in the LPP report for OTDOA, CSI RS is added as a member of the measurement report for DL TDOA, for example in NR-DL-TDOA-SignalMeasurementInformation
In a particular embodiment, the CSI-RS can be used as a source for UE-RX-TX as specified in 3GPP specification 38.215, replacing the PRS resource with a CSI-resource
   CSI-RS is added as a potential source for measurement in the assistance data of RTT, for example as a member of the NR-Multi-RTT-ProvideAssistanceData-r16 IE in the assistance data message from the Location server to the UE
   For reporting of DL-TDOA measurements, in the LPP report for OTDOA, CSI RS is added as a member of the measurement report for DL TDOA, for example in NR-NR-Multi-RTT-SignalMeasurementInformation

### RRC Reporting

As previously mentioned, RRC is already used for CSI reporting in many NR features, including positioning for E-CID. RRC has a lower latency than LPP for some architectures (such as multi-TRP) and is therefore an attractive candidate for handling the reporting positioning measurement when LPP is not strictly needed. One example is the case of an indoor deployment for a factory, where the nodes may be configured in a multi-TRP fashion. In this case, RRC would be more efficient as one node will collect all measurements via RRC and send the collected measurements to the location server. In one embodiment, the reporting of measurement information for positioning (e.g. DL-TDOA-SignalMeasurementInformation, NR-Multi-RTT-SignalMeasurementInformation, or other) is done using the RRC protocol.

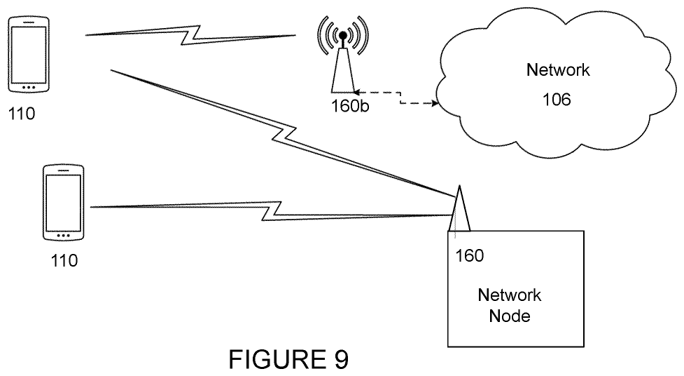

FIG. 9 illustrates a wireless network, in accordance with some embodiments. Although the subject matter described herein may be implemented in any appropriate type of system using any suitable components, the embodiments disclosed herein are described in relation to a wireless network, such as the example wireless network illustrated in FIG. 9. For simplicity, the wireless network of FIG. 9 only depicts network 106, network nodes 160 and 160b, and wireless devices 110. In practice, a wireless network may further include any additional elements suitable to support communication between wireless devices or between a wireless device and another communication device, such as a landline telephone, a service provider, or any other network node or end device. Of the illustrated components, network node 160 and wireless device 110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and wireless device 110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

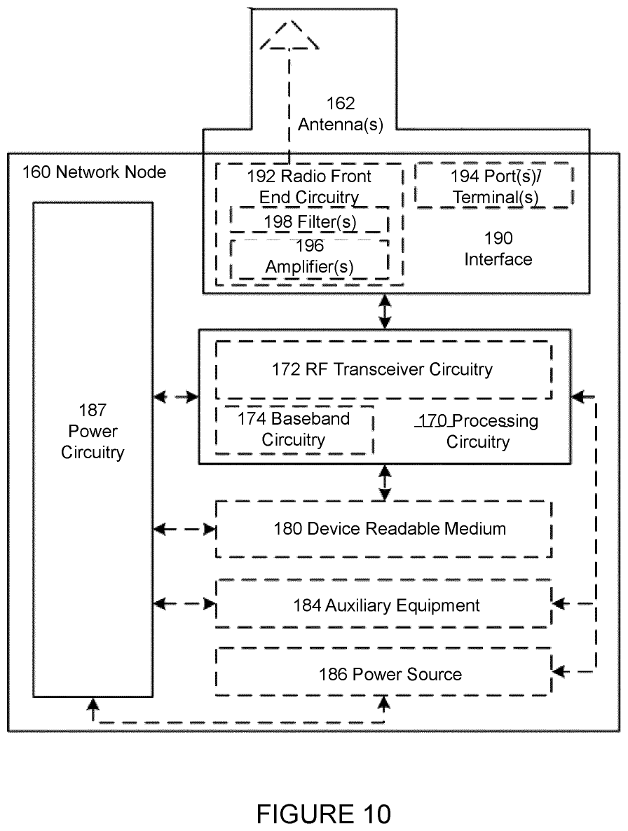

FIG. 10 illustrates an example network node 160, according to certain embodiments. As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 10, network node 160 includes processing circuitry 170, device readable medium 180, interface 190, auxiliary equipment 184, power source 186, power circuitry 187, and antenna 162. Although network node 160 illustrated in the example wireless network of FIG. 10 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality. For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units.

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signalling and/or data between network node 160, network 106, and/or wireless devices 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162. Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or wireless devices via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160. For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 10 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

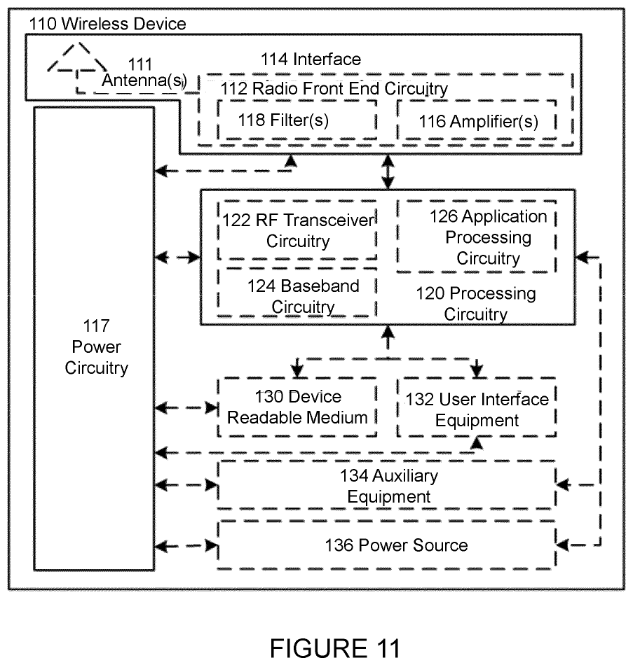

FIG. 11 illustrates an example wireless device 110. According to certain embodiments. As used herein, wireless device refers to a device capable, configured, arranged and/or operable to communicate wirelessly with network nodes and/or other wireless devices. Unless otherwise noted, the term wireless device may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a wireless device may be configured to transmit and/or receive information without direct human interaction. For instance, a wireless device may be designed to transmit information to a network on a predetermined schedule, when triggered by an internal or external event, or in response to requests from the network. Examples of a wireless device include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A wireless device may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a wireless device may represent a machine or other device that performs monitoring and/or measurements and transmits the results of such monitoring and/or measurements to another wireless device and/or a network node. The wireless device may in this case be a machine-to-machine (M2M) device, which may in a 3GPP context be referred to as an MTC device. As one particular example, the wireless device may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a wireless device may represent a vehicle or other equipment that is capable of monitoring and/or reporting on its operational status or other functions associated with its operation. A wireless device as described above may represent the endpoint of a wireless connection, in which case the device may be referred to as a wireless terminal. Furthermore, a wireless device as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. Wireless device 110 may include multiple sets of one or more of the illustrated components for different wireless technologies supported by wireless device 110, such as, for example, GSM, WCDMA, LTE, NR, WiFi, WiMAX, or Bluetooth wireless technologies, just to mention a few. These wireless technologies may be integrated into the same or different chips or set of chips as other components within wireless device 110.

Antenna 111 may include one or more antennas or antenna arrays, configured to send and/or receive wireless signals, and is connected to interface 114. In certain alternative embodiments, antenna 111 may be separate from wireless device 110 and be connectable to wireless device 110 through an interface or port. Antenna 111, interface 114, and/or processing circuitry 120 may be configured to perform any receiving or transmitting operations described herein as being performed by a wireless device. Any information, data and/or signals may be received from a network node and/or another wireless device. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120 and is configured to condition signals communicated between antenna 111 and processing circuitry 120. Radio front end circuitry 112 may be coupled to or a part of antenna 111. In some embodiments, wireless device 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114. Radio front end circuitry 112 may receive digital data that is to be sent out to other network nodes or wireless devices via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other wireless device 110 components, such as device readable medium 130, wireless device 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of wireless device 110 may comprise a SOC. In some embodiments, RF transceiver circuitry 122, baseband processing circuitry 124, and application processing circuitry 126 may be on separate chips or sets of chips. In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a wireless device may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner. In any of those particular embodiments, whether executing instructions stored on a device readable storage medium or not, processing circuitry 120 can be configured to perform the described functionality. The benefits provided by such functionality are not limited to processing circuitry 120 alone or to other components of wireless device 110, but are enjoyed by wireless device 110 as a whole, and/or by end users and the wireless network generally.

Processing circuitry 120 may be configured to perform any determining, calculating, or similar operations (e.g., certain obtaining operations) described herein as being performed by a wireless device. These operations, as performed by processing circuitry 120, may include processing information obtained by processing circuitry 120 by, for example, converting the obtained information into other information, comparing the obtained information or converted information to information stored by wireless device 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be considered to be integrated.

User interface equipment 132 may provide components that allow for a human user to interact with wireless device 110. Such interaction may be of many forms, such as visual, audial, tactile, etc. User interface equipment 132 may be operable to produce output to the user and to allow the user to provide input to wireless device 110. The type of interaction may vary depending on the type of user interface equipment 132 installed in wireless device 110. For example, if wireless device 110 is a smart phone, the interaction may be via a touch screen; if wireless device 110 is a smart meter, the interaction may be through a screen that provides usage (e.g., the number of gallons used) or a speaker that provides an audible alert (e.g., if smoke is detected). User interface equipment 132 may include input interfaces, devices and circuits, and output interfaces, devices and circuits. User interface equipment 132 is configured to allow input of information into wireless device 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from wireless device 110, and to allow processing circuitry 120 to output information from wireless device 110. User interface equipment 132 may include, for example, a speaker, a display, vibrating circuitry, a USB port, a headphone interface, or other output circuitry. Using one or more input and output interfaces, devices, and circuits, of user interface equipment 132, wireless device 110 may communicate with end users and/or the wireless network and allow them to benefit from the functionality described herein.

Auxiliary equipment 134 is operable to provide more specific functionality which may not be generally performed by wireless devices. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. wireless device 110 may further comprise power circuitry 137 for delivering power from power source 136 to the various parts of wireless device 110 which need power from power source 136 to carry out any functionality described or indicated herein. Power circuitry 137 may in certain embodiments comprise power management circuitry. Power circuitry 137 may additionally or alternatively be operable to receive power from an external power source; in which case wireless device 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of wireless device 110 to which power is supplied.

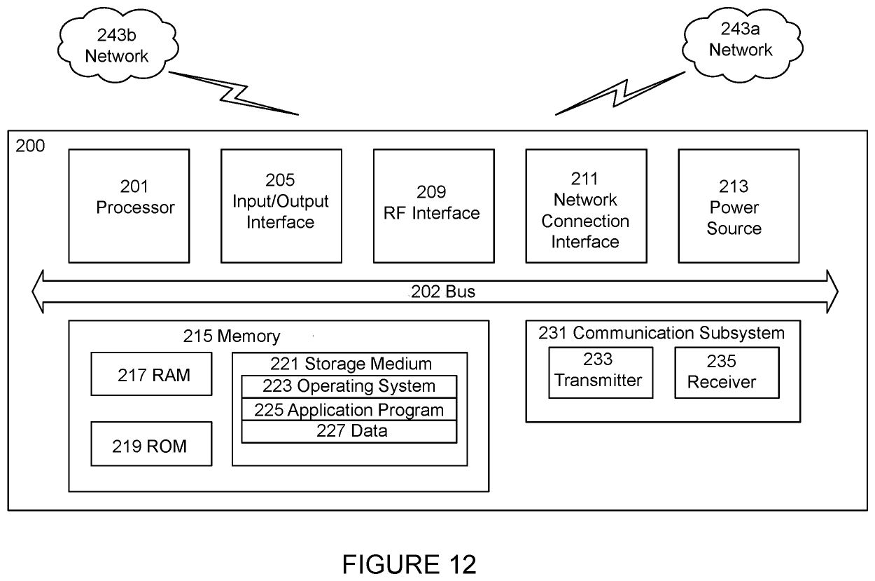

FIG. 12 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 10, is one example of a wireless device configured for communication in accordance with one or more communication standards promulgated by the 3^{rd} Generation Partnership Project (3GPP), such as 3GPP's GSM, UMTS, LTE, and/or 5G standards. As mentioned previously, the term wireless device and UE may be used interchangeable. Accordingly, although FIG. 12 is a UE, the components discussed herein are equally applicable to a wireless device, and vice-versa.

In FIG. 12, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 233, and/or any other component, or any combination thereof. Storage medium 221 includes operating system 223, application program 225, and data 227. In other embodiments, storage medium 221 may include other similar types of information. Certain UEs may utilize all of the components shown in FIG. 12, or only a subset of the components. The level of integration between the components may vary from one UE to another UE. Further, certain UEs may contain multiple instances of a component, such as multiple processors, memories, transceivers, transmitters, receivers, etc.

In FIG. 12, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205. An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof. UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 12, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory. Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 12, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another wireless device, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

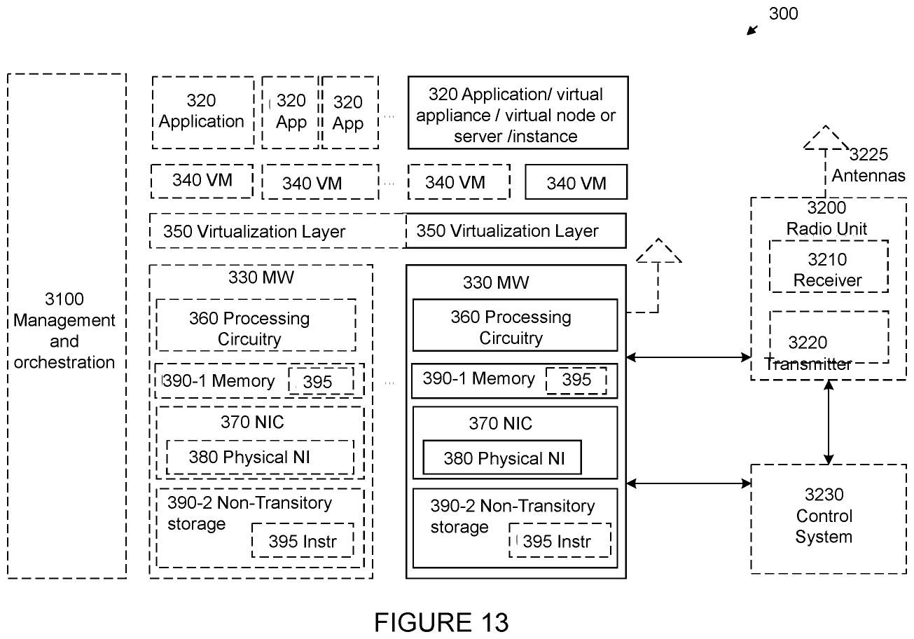

FIG. 13 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 13, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 13.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signaling can be affected with the use of control system 3230 which may alternatively be used for communication between the hardware nodes 330 and radio units 3200.

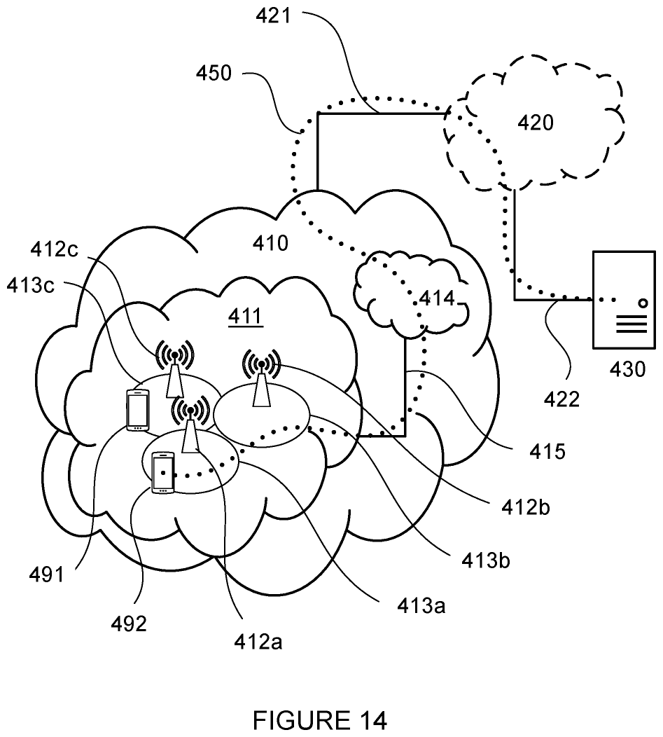

FIG. 14 illustrates a telecommunication network connected via an intermediate network to a host computer in accordance with some embodiments.

With reference to FIG. 14, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 14 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

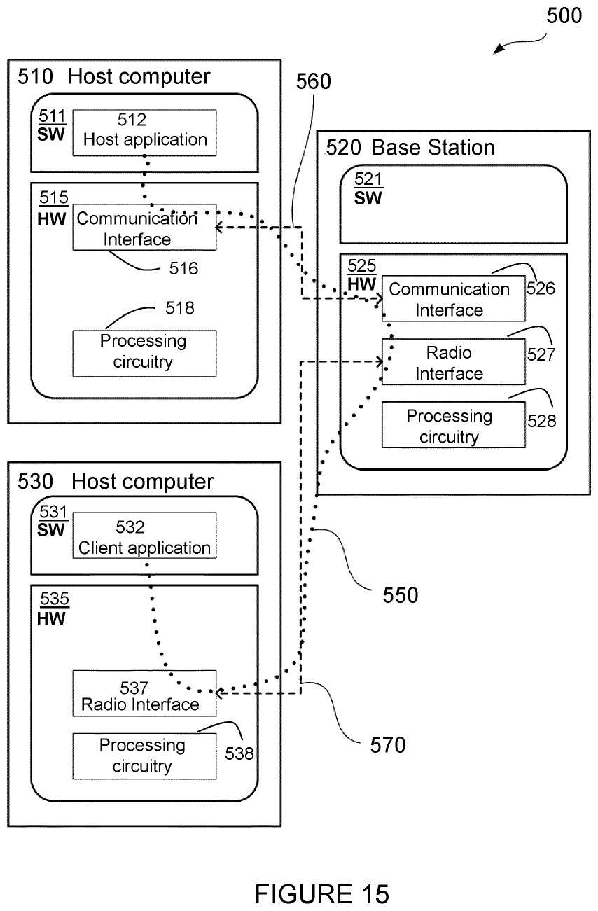

FIG. 15 illustrates a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 15. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 15) served by base station 520. Communication interface 526 may be configured to facilitate connection 560 to host computer 510. Connection 560 may be direct or it may pass through a core network (not shown in FIG. 15) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 15 may be similar or identical to host computer 430, one of base stations 412a, 412b, 412c and one of UEs 491, 492 of FIG. 14, respectively. This is to say, the inner workings of these entities may be as shown in FIG. 15 and independently, the surrounding network topology may be that of FIG. 14.

In FIG. 15, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the data rate, latency, and/or power consumption and thereby provide benefits such as reduced user waiting time, relaxed restriction on file size, better responsiveness, and/or extended battery lifetime.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530. or both. In embodiments, sensors (not shown) may be deployed in or in association with communication devices through which OTT connection 550 passes; the sensors may participate in the measurement procedure by supplying values of the monitored quantities exemplified above or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

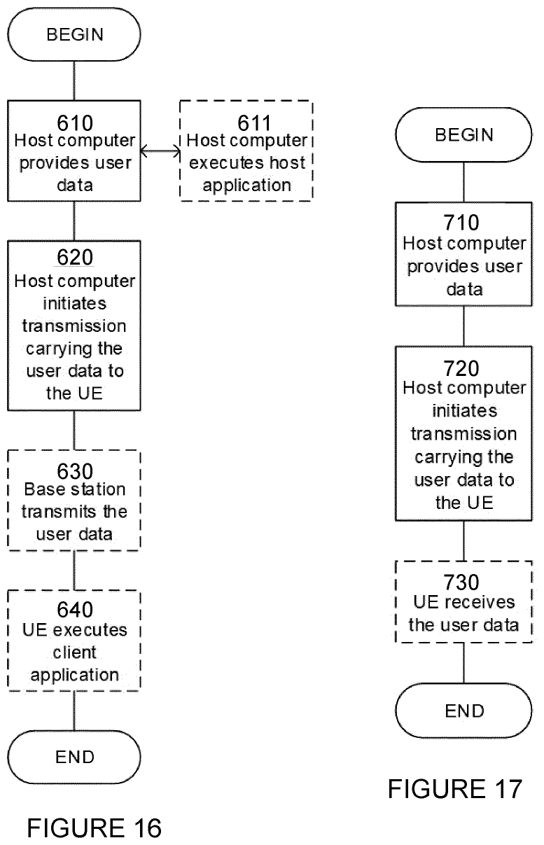

FIG. 16 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 16 will be included in this section. In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 17 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 17 will be included in this section. In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

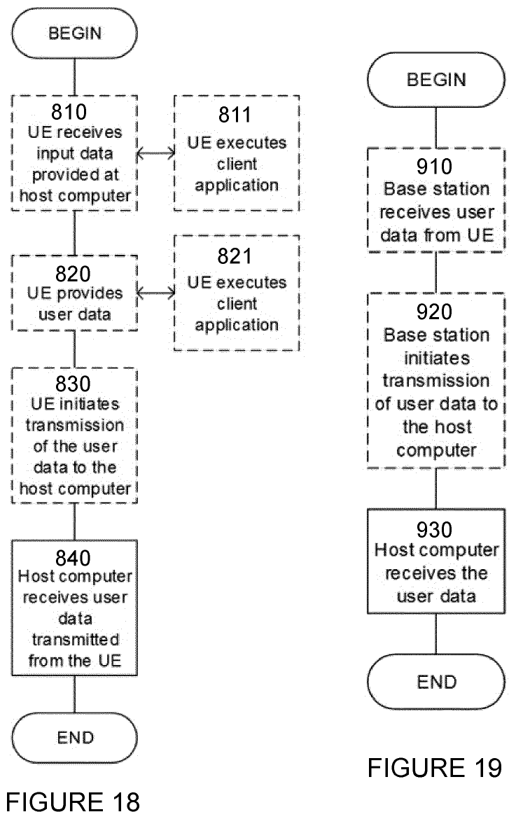

FIG. 18 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 18 will be included in this section. In step 810 (which may be optional), the UE receives input data provided by the host computer. Additionally or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 19 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 19 will be included in this section. In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

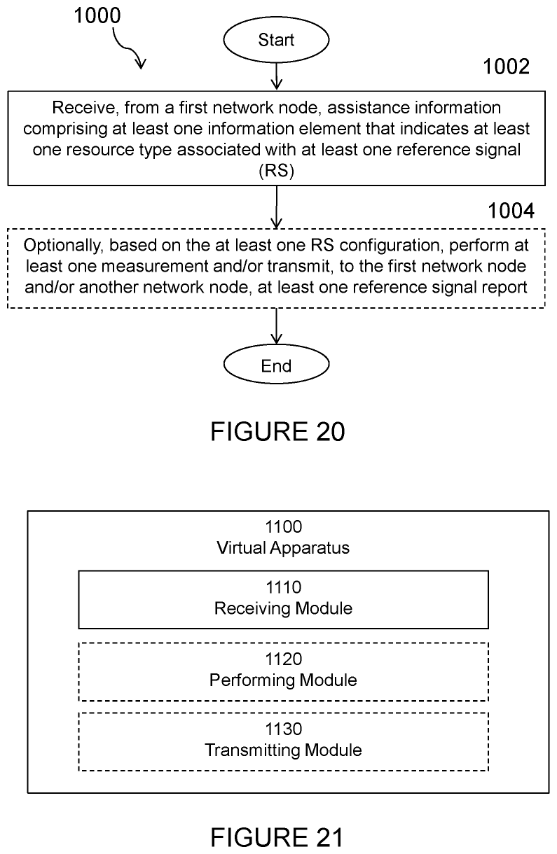

FIG. 20 depicts a method 1000 by a wireless device 110, according to certain embodiments. At step 1002, the wireless device receives, from a first network node 160, assistance information comprising at least one information element that indicates at least one resource type associated with at least one RS. Optionally, at step 1004, based on the at least one RS configuration, the wireless device may perform at least one measurement and/or transmit, to the first network node and/or another network node, at least one reference signal report.

FIG. 21 illustrates a schematic block diagram of a virtual apparatus 1100 in a wireless network (for example, the wireless network shown in FIG. 9). The apparatus may be implemented in a wireless device or network node (e.g., wireless device 110 or network node 160 shown in FIG. 9). Apparatus 1100 is operable to carry out the example method described with reference to FIG. 20 and possibly any other processes or methods disclosed herein. It is also to be understood that the method of FIG. 20 is not necessarily carried out solely by apparatus 1100. At least some operations of the method can be performed by one or more other entities.

Virtual Apparatus 1100 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving module 1110 and any other suitable modules and/or units of apparatus 1100 such, for example, an optional performing module 1120 and/or transmitting module 1130, to perform corresponding functions according one or more embodiments of the present disclosure.

According to certain embodiments, receiving module 1110 may perform certain of the receiving functions of the apparatus 1100. For example, receiving module 1110 may receive, from a first network node 160, assistance information comprising at least one information element that indicates at least one resource type associated with at least one reference signal (RS).

According to certain embodiments, an optional performing module 1120 may perform certain of the performing functions of the apparatus 1100. For example, performing module 1120 may perform at least one RS configuration based on the at least one RS configuration.

According to certain embodiments, an optional transmitting module 1130 may perform certain of the transmitting functions of the apparatus 1100. For example, transmitting module 1130 may transmit, to the first network node and/or another network node, at least one reference signal report based on the at least one RS configuration.

As used herein, the term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

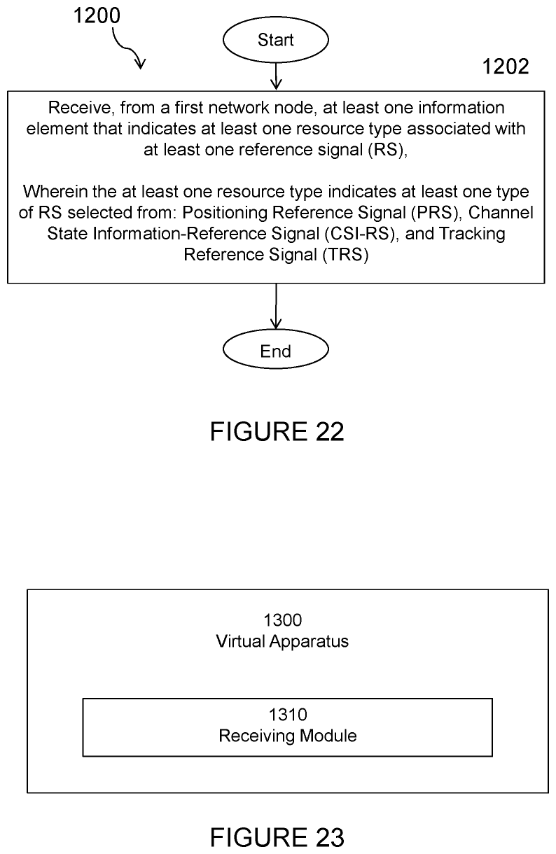

FIG. 22 depicts another method 1200 by a wireless device 110, according to certain embodiments. At step 1202, the wireless device receives, from a first network node at least one information element that indicates at least one resource type associated with at least one RS. The at least one resource type indicates at least one type of RS selected from: PRS; CSI-RS; and TRS.

In a particular embodiment, the information element includes at least one value of a plurality of values, and each of the plurality of values is associated with a RS configuration.

In a particular embodiment, the at least one information element indicates the at least one resource type triggers a type of reporting selected from periodic, aperiodic, or semipersistent.

In a particular embodiment, the first network node is operating as a LMF. In a further particular embodiment, the at least one element is received according to a LPP.

In a particular embodiment, the first network node is a serving gNodeB and the at least one resource type associated with the at least one RS is associated with a serving cell. In a further particular embodiment, the at least one element is received according to a Radio Resource Control, RRC, protocol.

In a particular embodiment, the at least one information element is for a DCI that indicates at least one RS configuration.

In a particular embodiment, the wireless device receives at least one information element, via RRC signaling, providing a plurality of RS configurations. The wireless device also receives a DCI that indicates at least one RS configuration within the plurality of RS configurations.

In a further particular embodiment, based on the at least one RS configuration, the wireless device performs at least one measurement. Based on the at least one RS configuration, the wireless device transmits, to the first network node and/or another network node, at least one measurement report.

In a particular embodiment, the at least one measurement comprises at least one of: a RSTD; a RSRP; a RSRQ; and a UE RX-TX.

In a further particular embodiment, the measurement report is transmitted to the network node and/or the other network node via RRC protocol.

In a particular embodiment, the at least one RS configuration comprises a plurality of RS configurations. In a further particular embodiment, the plurality of RS configurations comprise, at least, a PRS configuration, a TRS configuration, and a CSI-RS configuration.

In a further particular embodiment, the PRS configuration, the TRS configuration, and the CSI-RS configuration are indicated by the at least one information element.

In a further particular embodiment, the PRS configuration is indicated by a first information element and the CSI-RS configuration and/or TRS configuration is indicated by a second information element.

In a further particular embodiment, the at least one RS configuration is received via a CSI-AssociatedReportReportConfigInfo,

In a particular embodiment, the at least one RS configuration is associated with at least one of: NR DL-TDOA, NR-DL-AoD, and NR Multi-RTT.

In a particular embodiment, the at least one resource type comprises at least one of: at least one resource identifier (ID), at least one resource set ID, or at least one frequency layer ID.

In a particular embodiment, the at least one resource type comprises at least one of: at least one PRS resource ID, at least one PRS resource set ID, or a list of PRS resource sets.

In a particular embodiment, the at least one element and/or the at least one resource type includes at least one codepoint, each of the at least one codepoint(s) being associated with a PRS configuration associated with a respective one of a plurality of network nodes.

FIG. 23 illustrates a schematic block diagram of a virtual apparatus 1300 in a wireless network (for example, the wireless network shown in FIG. 9). The apparatus may be implemented in a wireless device or network node (e.g., wireless device 110 or network node 160 shown in FIG. 9). Apparatus 1300 is operable to carry out the example method described with reference to FIG. 22 and possibly any other processes or methods disclosed herein. It is also to be understood that the method of FIG. 23 is not necessarily carried out solely by apparatus 1300. At least some operations of the method can be performed by one or more other entities.

Virtual Apparatus 1300 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving module 1310 and any other suitable modules and/or units of apparatus 1300 to perform corresponding functions according one or more embodiments of the present disclosure.

According to certain embodiments, receiving module 1310 may perform certain of the receiving functions of the apparatus 1300. For example, receiving module 1310 may receive, from a first network node, at least one information element that indicates at least one resource type associated with at least one RS. The at least one resource type indicates at least one type of RS selected from: PRS; CSI-RS; and TRS.

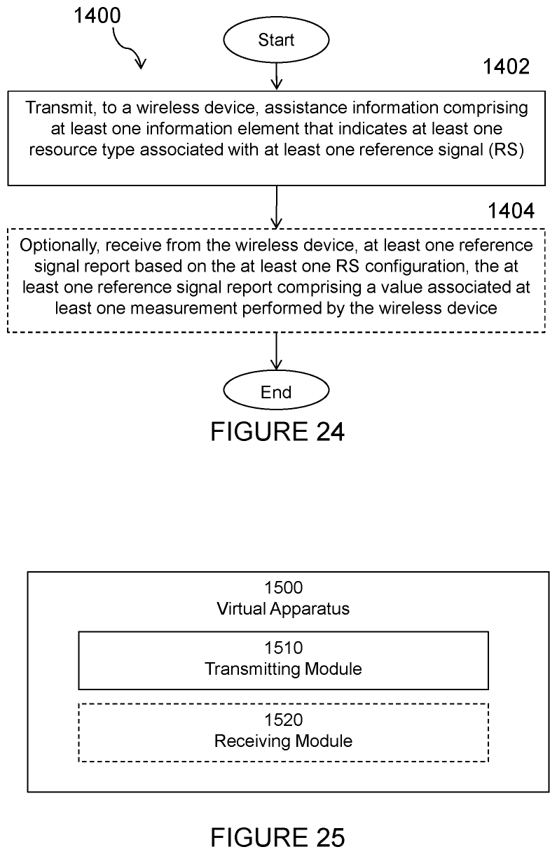

FIG. 24 depicts a method 1400 by a network node 160, according to certain embodiments. At step 1402, the network node transmits, to a wireless device 160, assistance information comprising at least one information element that indicates at least one resource type associated with at least one RS. Optionally, at step 1404, the network node may receive, from the wireless device, at least one reference signal report based on the at least one RS configuration. The at least one reference signal report may include a value associated with at least one measurement performed by the wireless device based on the assistance information.

FIG. 25 illustrates a schematic block diagram of a virtual apparatus 1500 in a wireless network (for example, the wireless network shown in FIG. 9). The apparatus may be implemented in a wireless device or network node (e.g., wireless device 110 or network node 160 shown in FIG. 9). Apparatus 1500 is operable to carry out the example method described with reference to FIG. 24 and possibly any other processes or methods disclosed herein. It is also to be understood that the method of FIG. 4 is not necessarily carried out solely by apparatus 1500. At least some operations of the method can be performed by one or more other entities.

Virtual Apparatus 1500 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause transmitting module 1510 and any other suitable modules and/or units of apparatus 1500, such as, for example, optional receiving module 1520, to perform corresponding functions according one or more embodiments of the present disclosure.

According to certain embodiments, transmitting module 1510 may perform certain of the transmitting functions of the apparatus 1500. For example, transmitting module 1510 may transmit, to a wireless device 160, assistance information comprising at least one information element that indicates at least one resource type associated with at least one reference signal (RS).

According to a particular embodiment, an optional receiving module 1520 may perform certain of the receiving functions of the apparatus 1500. For example, optional receiving module 1520 may receive, from the wireless device, at least one reference signal report based on the at least one RS configuration. The at least one reference signal report may include a value associated with at least one measurement performed by the wireless device based on the assistance information.

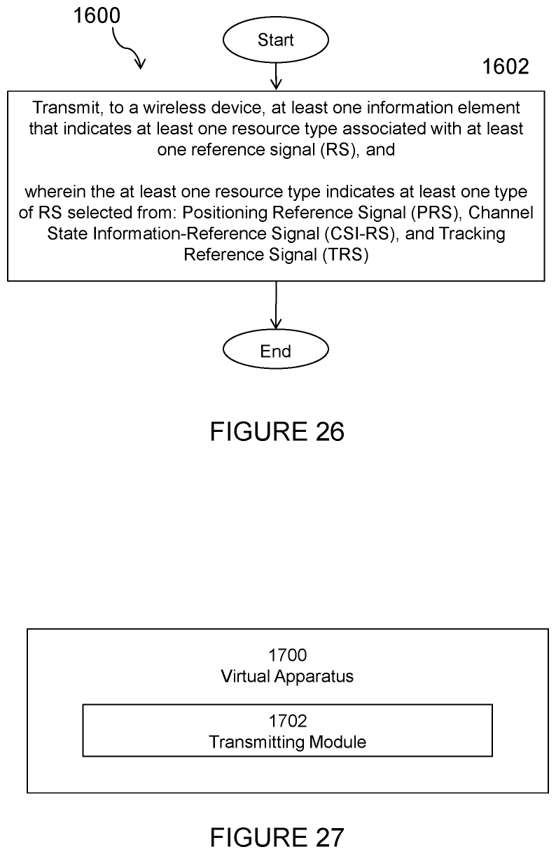

FIG. 26 depicts another method 1600 by a network node 160, according to certain embodiments. At step 1602, the network node transmits, to a wireless device, at least one information element that indicates at least one resource type associated with at least one RS. The at least one resource type indicates at least one type of RS selected from: PRS; CSI-RS; and TRS.

In a particular embodiment, the at least one information element comprises at least one value of a plurality of values, each of the plurality of values being associated with a RS configuration.

In a particular embodiment, the at least one information element indicates the at least one resource type triggers a type of reporting selected from periodic, aperiodic, or semipersistent.

In a particular embodiment, the first network node is operating as a LMF.

In a particular embodiment, the at least one information element is received according to a LPP.

In a particular embodiment, the network node 160 receives at least one RS configuration from at least one other network node operating as a gNodeB. Based on the at least one RS configuration received from the at least one other network node, the network node transmits the at least one information element comprising the resource type.

In a further particular embodiment, the network node 160 transmits, to each of the at least one other network nodes, at least one request for the at least one RS configuration.

In a particular embodiment, the at least one other network node comprises a serving gNodeB associated with a serving cell of the wireless device.

In a further particular embodiment, the at least one other network node comprises a secondary gNodeB associated with a serving cell or a neighboring cell.

In a particular embodiment, the at least one resource type associated the at least one RS that is transmitted to the wireless device includes a RS configuration that is common to each of the at least one other network nodes.

In a particular embodiment, the network node 160 maintains at least one codepoint. Each codepoint is associated with a PRS configuration received from respective one of the at least one other network nodes. In a further particular embodiment, the at least one information element indicates the at least one resource type comprises the at least one codepoint.

In a particular embodiment, the network node 160 is a serving gNodeB associated with a serving cell and the resource type associated with the RS is associated with a RS configuration of the network node. In a further particular embodiment, the at least one information element is transmitted to the wireless device according to a RRC protocol.

In a particular embodiment, the at least one information element is for a downlink control information, DCI, that indicates at least one RS configuration.

In a further particular embodiment, the network node 160 receives, from the wireless device 110, at least one measurement report based on the at least one RS configuration. The at least one measurement report includes a value associated with at least one measurement performed by the wireless device. In a further particular embodiment, the at least one measurement comprises at least one of: a RSTD; a RSRP; a RSRQ; and a UE RX-TX.

In a further particular embodiment, the at least one RS configuration comprises a plurality of RS configurations. In a further particular embodiment, the plurality of RS configurations comprise, at least, a PRS configuration, a TRS configuration, and a CSI-RS configuration.

In a further particular embodiment, the PRS configuration, the TRS configuration, and the CSI-RS configuration are indicated by the at least one information element.

In a further particular embodiment, the PRS configuration is indicated by a first information element and the CSI-RS configuration and/or TRS configuration is indicated by a second information element.

In a further particular embodiment, the at least one RS configuration is received via a CSI-AssociatedReportReportConfigInfo. In a further particular embodiment, the RS configuration is associated with at least one of: NR DL-TDOA, NR-DL-AoD, and NR Multi-RTT.

In a particular embodiment, the at least one resource type comprises at least one of: at least one resource identifier, at least one resource set identifier, or at least one frequency layer identifier.

In a particular embodiment, the at least one resource type comprises at least one of: at least one PRS resource identifier, at least one PRS resource set identifier, or a list of PRS resource sets.

FIG. 27 illustrates a schematic block diagram of a virtual apparatus 1700 in a wireless network (for example, the wireless network shown in FIG. 9). The apparatus may be implemented in a wireless device or network node (e.g., wireless device 110 or network node 160 shown in FIG. 9). Apparatus 1700 is operable to carry out the example method described with reference to FIG. 26 and possibly any other processes or methods disclosed herein. It is also to be understood that the method of FIG. 4 is not necessarily carried out solely by apparatus 1700. At least some operations of the method can be performed by one or more other entities.

Virtual Apparatus 1700 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause transmitting module 1710 and any other suitable modules and/or units of apparatus 1700 to perform corresponding functions according one or more embodiments of the present disclosure.

According to certain embodiments, transmitting module 1710 may perform certain of the transmitting functions of the apparatus 1700. For example, transmitting module 1710 may transmit, to a wireless device 160, at least one information element that indicates at least one resource type associated with at least one RS. The at least one resource type indicates at least one type of RS selected from: PRS; CSI-RS; and TRS.

### EXAMPLE EMBODIMENTS

### Group A Example Embodiments

Example Embodiment A1. A method by a wireless device comprising: receiving, from a first network node, assistance information comprising at least one information element that indicates at least one resource type associated with at least one reference signal (RS).

Example Embodiment A2. The method of Example Embodiment A1, wherein the information element comprises at least one value of a plurality of values, each of the plurality of values being associated with a RS configuration.

Example Embodiment A3 The method of any one of Example Embodiments A1 to A2, wherein the at least one information element indicating the at least one resource type triggers a type of reporting selected from periodic, aperiodic, or semipersistent.

Example Embodiment A4 The method of any one of Example Embodiments A1 to A3, wherein the at least one resource type indicates at least one type of RS selected from Positioning Reference Signal (PRS), Channel State Information-Reference Signal (CSI-RS), and Tracking Reference Signal (TRS).

Example Embodiment A5a. The method of any one of Example Embodiments A1 to A4, wherein the first network node is operating as a location management function.

Example Embodiment A5b. The method of any one of Example Embodiments A1 to A4, wherein the first network node is a serving gNodeB and the at least one resource type associated with the at least one RS is associated with a serving cell.

Example Embodiment A6. The method of any one of Example Embodiments A1 to A5b, wherein the assistance information is received according to a LTE Positioning Protocol (LPP).

Example Embodiment A7. The method of any one of Example Embodiments A1 to A5, wherein the assistance information is received according to a Radio Resource Control (RRC) protocol.

Example Embodiment A8. The method of any one of Example Embodiments A1 to A5, wherein the assistance information is received according to a New Radio Positioning Protocol A (NRPPa).

Example Embodiment A9. The method of any one of Example Embodiments A1 to A8, wherein the assistance information is received via downlink control information (DCI), the assistance information comprising at least one RS configuration, the at least one RS configuration being connected to a DCI triggering state.

Example Embodiment A10. The method of Example Embodiment A9, further comprising: based on the at least one RS configuration, performing, by the wireless device, at least one measurement; and based on the at least one RS configuration transmitting, to the first network node and/or another network node, at least one reference signal report.

Example Embodiment A11a. The method of Example Embodiment A10, wherein the at least one measurement comprises at least one of: a Reference Signal Time Difference (RSTD), a Reference Signal Received Power (RSRP), a Reference Signal Received Quality (RSRQ), and a UE Receiver/Transmitter (UE RX-TX).

Example Embodiment A11b. The method of any one of Example Embodiments A10 to A11a, wherein the at least one reference signal report is transmitted to the network node and/or the other network node via RRC protocol.

Example Embodiment A12. The method of any one of Example Embodiments A9 to A11, wherein the at least one RS configuration comprises a plurality of RS configurations.

Example Embodiment A13a. The method of Example Embodiment A12, wherein the plurality of RS configurations comprise, at least, a PRS configuration and a CSI-RS configuration.

Example Embodiment A13b. The Example Embodiment of A13, wherein the PRS configuration and the CSI-RS configuration are indicated by the at least one information element.

Example Embodiment A13c. The Example Embodiment of A13, wherein the PRS configuration is indicated by a first information element and the CSI-RS configuration is indicated by a second information element.

Example Embodiment A13d. The method of Example Embodiments A9 to A11, wherein the at least one RS configuration comprises a single RS configuration that is common to a plurality of network nodes.

Example Embodiment A14. The method of any one of Example Embodiments A9 to A13, wherein the at least one RS configuration is received via a CSI-AssociatedReportReportConfigInfo, and wherein the at least one RS configuration is associated with at least one of: NR DL-TDOA, NR-DL-AoD, and NR Multi-RTT.

Example Embodiment A15. The method of any one of Example Embodiments A1 to A14, wherein the at least one resource type comprises at least one of: at least one resource identifier (ID), at least one resource set ID, or at least one frequency layer ID.

Example Embodiment A16. The method of any one of Example Embodiments A1 to A15, wherein the at least one resource type comprises at least one of: at least one PRS resource ID, at least one PRS resource set ID, or a list of PRS resource sets.

Example Embodiment A17. The method of any one of Example Embodiments A1 to A16, further comprising performing at least one action based on the at least one resource type associated with the at least one RS.

Example Embodiment A18. The method of Example Embodiment A17, wherein the at least one action comprises at least one of: performing, by the wireless device, at least one measurement; and based on the at least one RS configuration transmitting, to the first network node and/or another network node, at least one reference signal report.

Example Embodiment A19. The method of Example Embodiment A18, wherein the at least one reference signal report is transmitted to the first network node and/or the other network node via RRC protocol.

Example Embodiment A20. The method of any one of Example Embodiments A6 to B18, wherein the assistance information and/or the at least one resource type comprises at least one codepoint, each of the at least one codepoint(s) being associated with a PRS configuration associated with a respective one of a plurality of network nodes.

Example Embodiment A21. The method of Example Embodiment A20, wherein each of the at least one codepoints indicates at least one of: periodic, semi-persistent, or aperiodic; a number of resource sets and/or a number of resources; a periodicity; a comb pattern; a number of PRS subframes; a PRS bandwidth; and a frequency layer.

Example Embodiment A22. A wireless device comprising processing circuitry configured to perform any of the methods of Example Embodiments A1 to A21.

Example Embodiment A23. A computer program comprising instructions which when executed on a computer perform any of the methods of Example Embodiments A1 to A21.

Example Embodiment A24. A computer program product comprising computer program, the computer program comprising instructions which when executed on a computer perform any of the methods of Example Embodiments A1 to A21.

Example Embodiment A25. A non-transitory computer readable medium storing instructions which when executed by a computer perform any of the methods of Example Embodiments A1 to A21.

### Group B Embodiments

Example Embodiment B1. A method by a first network node comprising: transmitting, to a wireless device, assistance information comprising at least one information element that indicates at least one resource type associated with at least one reference signal (RS).

Example Embodiment B2. The method of Example Embodiment B1, wherein the at least one information element comprises at least one value of a plurality of values, each of the plurality of values being associated with a RS configuration.

Example Embodiment B3 The method of any one of Example Embodiments B1 to B2, wherein the at least one information element indicating the at least one resource type triggers a type of reporting selected from periodic, aperiodic, or semipersistent.

Example Embodiment B4 The method of any one of Example Embodiments B1 to B3, wherein the at least one resource type indicates at least one type of RS, the at least one type of RS comprising Positioning Reference Signal (PRS), Channel State Information-Reference Signal (CSI-RS), and/or Tracking Reference Signal (TRS).

Example Embodiment B5. The method of any one of Example Embodiments B1 to B4, further wherein the first network node is operating as a location management function.

Example Embodiment B6. The method of Example Embodiment B5, further comprising: receiving at least one RS configuration from at least one other network node operating as a gNodeB; and based on the at least one RS configuration received from the at least one other network node, transmitting the assistance information comprising the resource type.

Example Embodiment B7. The method of Example Embodiment B6, further comprising transmitting, to each of the at least one other network nodes, at least one request for the at least one RS configuration.

Example Embodiment B8. The method of any one of Example Embodiments B6 to B7, wherein the at least one request is transmitted to each of the at least one other network nodes via NRPPa or OAM and wherein the at least one RS configuration is received from each of the at least one other network nodes via NRPPa or OAM.

Example Embodiment B9. The method of any one of Example Embodiments B6 to B8, wherein the at least one other network node comprises a serving gNodeB associated with a serving cell of the wireless device.

Example Embodiment B10. The method of any one of Example Embodiments B6 to B9, wherein the at least one other network node comprises a secondary gNodeB associated with a serving cell or a neighboring cell.

Example Embodiment B11. The method of any one of Example Embodiments B6 to B10, wherein the at least one resource type associated the at least one RS that is transmitted to the wireless device comprises a RS configuration, the RS configuration being common to each of the at least one other network nodes.

Example Embodiment B12. The method of any one of Example Embodiments B6 to B11, further comprising maintaining at least one codepoint, each of the at least one codepoint being associated with a PRS configuration received from respective one of the at least one other network nodes.

Example Embodiment B13. The method of Example Embodiment B12, wherein each of the at least one codepoints indicates at least one of: periodic, semi-persistent, or aperiodic; a number of resource sets and/or a number of resources; a periodicity; a comb pattern; a number of PRS subframes; a PRS bandwidth; and a frequency layer.

Example Embodiment B14. The method of any one of Example Embodiments B12 to B13, wherein the assistance information indicating the at least one resource type comprises the at least one codepoint.

Example Embodiment B15. The method of any one of Example Embodiments B1 to B4, wherein the network node is a serving gNodeB associated with a serving cell and the resource type associated with the RS is associated with a RS configuration of the network node.

Example Embodiment B16. The method of any one of Example Embodiments B1 to B15, wherein the assistance information is transmitted to the wireless device according to a LTE Positioning Protocol (LPP).

Example Embodiment B17. The method of any one of Example Embodiments B1 to B15, wherein the assistance information is transmitted to the wireless device according to a Radio Resource Control (RRC) protocol.

Example Embodiment B18. The method of any one of Example Embodiments B1 to B15, wherein the assistance information is transmitted to the wireless device according to a New Radio Positioning Protocol A (NRPPa).

Example Embodiment B19. The method of any one of Example Embodiments B1 to B18, wherein the assistance information is transmitted to the wireless device via downlink control information (DCI), and wherein the assistance information and/or the at least one resource type comprises at least one RS configuration, the at least one RS configuration being connected to a DCI triggering state.

Example Embodiment B20. The method of Example Embodiment B19, further comprising: receiving, from the wireless device, at least one reference signal report based on the at least one RS configuration, the at least one reference signal report comprising a value associated with at least one measurement performed by the wireless device.

Example Embodiment B21. The method of Example Embodiment B20, wherein the at least one measurement comprises at least one of: a Reference Signal Time Difference (RSTD), a Reference Signal Received Power (RSRP), a Reference Signal Received Quality (RSRQ), and a UE Receiver/Transmitter (UE RX-TX).

Embodiment The method of any one of Example Embodiments B19 to B21, wherein the at least one RS configuration comprises a plurality of RS configurations.

Example Embodiment B23. The method of Example Embodiment B22, wherein the plurality of RS configurations comprise, at least, a PRS configuration and a CSI-RS configuration.

Example Embodiment B24. The Example Embodiment of B23, wherein the PRS configuration and the CSI-RS configuration are indicated by the at least one information element.

Example Embodiment B25. The Example Embodiment of B23, wherein the PRS configuration is indicated by a first information element and the CSI-RS configuration is indicated by a second information element.

Example Embodiment B26. The method of any one of Example Embodiments B19 to B25, wherein the at least one RS configuration is received via a CSI-AssociatedReportReportConfigInfo, and wherein the RS configuration is associated with at least one of: NR DL-TDOA, NR-DL-AoD, and NR Multi-RTT.

Example Embodiment B27. The method of any one of Example Embodiments B1 to B26, wherein the at least one resource type comprises at least one of: at least one resource identifier (ID); at least one resource set ID; or at least one frequency layer ID.

Example Embodiment B28. The method of any one of Example Embodiments B1 to B26, wherein the at least one resource type comprises at least one of: at least one PRS resource ID, at least one PRS resource set ID, or a list of PRS resource sets.

Example Embodiment B29. The method of any one of Example Embodiments B1 to B28, further comprising receiving, from the wireless device, at least one reference signal report based on the assistance information, the at least one reference signal report comprising a value associated with at least one measurement performed by the wireless device.

Example Embodiment B30. The method of Example Embodiment B29, wherein the at least one measurement comprises at least one of: a Reference Signal Time Difference (RSTD), a Reference Signal Received Power (RSRP), a Reference Signal Received Quality (RSRQ), and a UE Receiver/Transmitter (UE RX-TX).

Example Embodiment B31. The method of any one of Example Embodiments B29 to B30, wherein the at least one reference signal report is received from the wireless device via RRC protocol.

Example Embodiment B32. A first network node comprising processing circuitry configured to perform any of the methods of Example Embodiments B1 to B31.

Example Embodiment B33. A computer program comprising instructions which when executed on a computer perform any of the methods of Example Embodiments B1 to B31.

Example Embodiment B34. A computer program product comprising computer program, the computer program comprising instructions which when executed on a computer perform any of the methods of Example Embodiments B1 to B31.

Example Embodiment B35. A non-transitory computer readable medium storing instructions which when executed by a computer perform any of the methods of Example Embodiments B1 to B31.

### Group C Example Embodiments

Example Embodiment C1. A wireless device comprising: processing circuitry configured to perform any of the steps of any of the Group A Example Embodiments; and power supply circuitry configured to supply power to the wireless device.

Example Embodiment C2. A network node comprising: processing circuitry configured to perform any of the steps of any of the Group B Example Embodiments; power supply circuitry configured to supply power to the wireless device.

Example Embodiment C3. A wireless device, the wireless device comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A Example Embodiments; an input interface connected to the processing circuitry and configured to allow input of information into the wireless device to be processed by the processing circuitry; an output interface connected to the processing circuitry and configured to output information from the wireless device that has been processed by the processing circuitry; and a battery connected to the processing circuitry and configured to supply power to the wireless device.

Example Embodiment C4. A communication system including a host computer comprising: processing circuitry configured to provide user data; and a communication interface configured to forward the user data to a cellular network for transmission to a wireless device, wherein the cellular network comprises a network node having a radio interface and processing circuitry, the network node's processing circuitry configured to perform any of the steps of any of the Group B Example Embodiments.

Example Embodiment C5. The communication system of the pervious embodiment further including the network node.

Example Embodiment C6. The communication system of the previous 2 embodiments, further including the wireless device, wherein the wireless device is configured to communicate with the network node.

Example Embodiment C7. The communication system of the previous 3 embodiments, wherein: the processing circuitry of the host computer is configured to execute a host application, thereby providing the user data; and the wireless device comprises processing circuitry configured to execute a client application associated with the host application.

Example Embodiment C8. A method implemented in a communication system including a host computer, a network node and a wireless device, the method comprising: at the host computer, providing user data; and at the host computer, initiating a transmission carrying the user data to the wireless device via a cellular network comprising the network node, wherein the network node performs any of the steps of any of the Group B Example Embodiments.

Example Embodiment C9. The method of the previous embodiment, further comprising, at the network node, transmitting the user data.

Example Embodiment C10. The method of the previous 2 embodiments, wherein the user data is provided at the host computer by executing a host application, the method further comprising, at the wireless device, executing a client application associated with the host application.

Example Embodiment C11. A wireless device configured to communicate with a network node, the wireless device comprising a radio interface and processing circuitry configured to performs the of the previous 3 embodiments.

Example Embodiment C12. A communication system including a host computer comprising: processing circuitry configured to provide user data; and a communication interface configured to forward user data to a cellular network for transmission to a wireless device. wherein the wireless device comprises a radio interface and processing circuitry, the wireless device's components configured to perform any of the steps of any of the Group A Example Embodiments.

Example Embodiment C13. The communication system of the previous embodiment, wherein the cellular network further includes a network node configured to communicate with the wireless device.

Example Embodiment C14. The communication system of the previous 2 embodiments, wherein: the processing circuitry of the host computer is configured to execute a host application, thereby providing the user data; and the wireless device's processing circuitry is configured to execute a client application associated with the host application.

Example Embodiment C15. A method implemented in a communication system including a host computer, a network node and a wireless device, the method comprising: at the host computer, providing user data; and at the host computer, initiating a transmission carrying the user data to the wireless device via a cellular network comprising the network node, wherein the wireless device performs any of the steps of any of the Group A Example Embodiments.

Example Embodiment C16. The method of the previous embodiment, further comprising at the wireless device, receiving the user data from the network node.

Example Embodiment C17. A communication system including a host computer comprising: communication interface configured to receive user data originating from a transmission from a wireless device to a network node, wherein the wireless device comprises a radio interface and processing circuitry, the wireless device's processing circuitry configured to perform any of the steps of any of the Group A Example Embodiments.

Example Embodiment C18. The communication system of the previous embodiment, further including the wireless device.

Example Embodiment C19. The communication system of the previous 2 embodiments, further including the network node, wherein the network node comprises a radio interface configured to communicate with the wireless device and a communication interface configured to forward to the host computer the user data carried by a transmission from the wireless device to the network node.

Example Embodiment C20. The communication system of the previous 3 embodiments, wherein: the processing circuitry of the host computer is configured to execute a host application; and the wireless device's processing circuitry is configured to execute a client application associated with the host application, thereby providing the user data.

Example Embodiment C21. The communication system of the previous 4 embodiments, wherein: the processing circuitry of the host computer is configured to execute a host application, thereby providing request data; and the wireless device's processing circuitry is configured to execute a client application associated with the host application, thereby providing the user data in response to the request data.

Example Embodiment C22. A method implemented in a communication system including a host computer, a network node and a wireless device, the method comprising: at the host computer, receiving user data transmitted to the network node from the wireless device, wherein the wireless device performs any of the steps of any of the Group A Example Embodiments.

Example Embodiment C23. The method of the previous embodiment, further comprising, at the wireless device, providing the user data to the network node.

Example Embodiment C24. The method of the previous 2 embodiments, further comprising: at the wireless device, executing a client application, thereby providing the user data to be transmitted; and at the host computer, executing a host application associated with the client application.

Example Embodiment C25. The method of the previous 3 embodiments, further comprising: at the wireless device, executing a client application; and at the wireless device, receiving input data to the client application, the input data being provided at the host computer by executing a host application associated with the client application, wherein the user data to be transmitted is provided by the client application in response to the input data.

Example Embodiment C26. A communication system including a host computer comprising a communication interface configured to receive user data originating from a transmission from a wireless device to a network node, wherein the network node comprises a radio interface and processing circuitry, the network node's processing circuitry configured to perform any of the steps of any of the Group B Example Embodiments.

Example Embodiment C27. The communication system of the previous embodiment further including the network node.

Example Embodiment C28. The communication system of the previous 2 embodiments, further including the wireless device, wherein the wireless device is configured to communicate with the network node.

Example Embodiment C29. The communication system of the previous 3 embodiments, wherein: the processing circuitry of the host computer is configured to execute a host application; the wireless device is configured to execute a client application associated with the host application, thereby providing the user data to be received by the host computer.

Example Embodiment C30. A method implemented in a communication system including a host computer, a network node and a wireless device, the method comprising: at the host computer, receiving, from the base station, user data originating from a transmission which the network node has received from the wireless device, wherein the wireless device performs any of the steps of any of the Group A Example Embodiments.

Example Embodiment C31. The method of the previous embodiment, further comprising at the network node receiving the user data from the wireless device.

Example Embodiment C32. The method of the previous 2 embodiments, further comprising at the network node, initiating a transmission of the received user data to the host computer.

Example Embodiment C33. The method of any of the previous embodiments, wherein the network node comprises a base station.

Example Embodiment C34. The method of any of the previous embodiments, wherein the wireless device comprises a user equipment (UE).

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods described herein without departing from the scope of the disclosure. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure.

1. A method by a wireless device comprising:
receiving, from a first network node, at least one information element that indicates at least one resource type associated with at least one reference signal, RS, and
wherein the at least one resource type indicates at least one type of RS selected from: Positioning Reference Signal, PRS; Channel State Information-Reference Signal, CSI-RS; and Tracking Reference Signal, TRS.

2. The method of claim 1, wherein the information element comprises at least one value of a plurality of values, each of the plurality of values being associated with a RS configuration.

3. The method of claim 1, wherein the at least one information element indicating the at least one resource type triggers a type of reporting selected from periodic, aperiodic, or semipersistent.

4. The method of claim 1, wherein the first network node is operating as a location management function.

5.-6. (canceled)

7. The method of claim 6, wherein the at least one information element is received according to a Radio Resource Control, RRC, configuration.

8.-9. (canceled)

10. The method of claim 8, further comprising:
based on the at least one RS configuration, performing, by the wireless device, at least one measurement; and
based on the at least one RS configuration transmitting, to the first network node and/or another network node, at least one measurement report.

11. The method of claim 10, wherein the at least one measurement comprises at least one of: a Reference Signal Time Difference, RSTD; a Reference Signal Received Power, RSRP; a Reference Signal Received Quality, RSRQ; and a UE RX-TX.

12.-21. (canceled)

22. A method by a first network node comprising:
transmitting, to a wireless device, assistance information comprising at least one information element that indicates at least one resource type associated with at least one reference signal, RS, and
wherein the at least one resource type indicates at least one type of RS selected from: Positioning Reference Signal, PRS; Channel State Information-Reference Signal, CSI-RS; and Tracking Reference Signal, TRS.

23. The method of claim 22, wherein the at least one information element comprises at least one value of a plurality of values, each of the plurality of values being associated with a RS configuration.

24. The method of claim 22, wherein the at least one information element indicating the at least one resource type triggers a type of reporting selected from periodic, aperiodic, or semipersistent.

25.-26. (canceled)

27. The method of claim 25, further comprising:
receiving at least one RS configuration from at least one other network node operating as a gNodeB; and
based on the at least one RS configuration received from the at least one other network node, transmitting the assistance information comprising the resource type.

28. The method of claim 27, further comprising transmitting, to each of the at least one other network nodes, at least one request for the at least one RS configuration.

29. The method of claim 27, wherein the at least one other network node comprises a serving gNodeB associated with a serving cell of the wireless device.

30.-33. (canceled)

34. The method of claim 22, wherein the network node is a serving gNodeB associated with a serving cell and the resource type associated with the RS is associated with a RS configuration of the network node.

35. The method of claim 22, wherein the assistance information is transmitted to the wireless device according to a Radio Resource Control, RRC, protocol.

36. The method of claim 22, wherein the at least one information element is for a downlink control information, DCI, that indicates at least one RS configuration.

37. The method of claim 36, further comprising:
receiving, from the wireless device, at least one measurement report based on the at least one RS configuration, the at least one measurement report comprising a value associated with at least one measurement performed by the wireless device.

38. The method of claim 37, wherein the at least one measurement comprises at least one of: a Reference Signal Time Difference, RSTD; a Reference Signal Received Power, RSRP; a Reference Signal Received Quality, RSRQ; and a UE RX-TX.

39.-46. (canceled)

47. A wireless device adapted to perform the method of claim 1.

48. A network node adapted to perform the method of claim 22.
